(19) United States
(12) Patent Application Publication
(10) Pub. No.: US 2014/0076656 A1
(43) Pub. Date: Mar. 20, 2014

(54) RELATIVE ROTATIONAL ANGULAR DISPLACEMENT DETECTION DEVICE, TORQUE DETECTION DEVICE, TORQUE CONTROL DEVICE, AND VEHICLE

(71) Applicant: YAMAHA HATSUDOKI KABUSHIKI KAISHA, Shizuoka-ken (JP)

(72) Inventors: Hiroshi TANAKA, Shizuoka-ken (JP); Kazuto NAKAMURA, Shizuoka-ken (JP)

(73) Assignee: YAMAHA HATSUDOKI KABUSHIKI KAISHA, Shizuoka-ken (JP)

(21) Appl. No.: 14/024,078

(22) Filed: Sep. 11, 2013

(30) Foreign Application Priority Data
Sep. 14, 2012 (JP) 2012-202580

(51) Int. Cl. H02P 6/00; G01L 3/10; B62D 5/04; G01B 7/30

(52) U.S. Cl. CPC H02P 6/00; G01B 7/30; G01L 3/104; B62D 5/0463
USPC 180/446; 324/207.13; 73/862.325; 318/647

(57) ABSTRACT

A permanent magnet includes magnetic poles that are arranged so as to alternate in polarity in the circumferential direction of the axis of rotation. The magnet is attached to one of a pair of rotatable members. The rotatable members are relatively rotatable about an axis of rotation. A magnetic flux inducing ring, including an annular ring body and a plurality of protrusions protruding from the ring body, is attached to the other rotatable member. A plurality of magnetic sensors is arranged adjacent to the ring body. A first facing portion and a second facing portion, each for inducing a part of a magnetic flux of the ring body, are provided and do not rotate with the permanent magnet and the magnetic flux inducing ring.

### CROSS-REFERENCE TO RELATED APPLICATIONS

This application claims priority under 35 U.S.C. §119 to Japanese Patent Application No. 2012-202580, filed on Sep. 14, 2012, the entire disclosure of which is incorporated herein by reference in its entirety.

### BACKGROUND OF THE INVENTION

1. Field of the Invention

The present invention relates to, inter alia, a relative rotational angular displacement detection device used to detect a relative rotational angular displacement of a pair of rotatable members arranged coaxially with each other.

More specifically, the present invention relates to a relative rotational angular displacement detection device preferably for use in a power assist system for, e.g., a power assist wheelchair, a power assist bicycle, a power steering wheel, etc. The present invention also relates to a torque detection device using the relative rotational angular displacement detection device, and a torque control device using the relative rotational angular displacement detection device. It also relates to a power assist wheelchair, a power assist straddle-type vehicle, and a power steering device equipped with the torque control device.

2. Description of the Related Art

For example, in a conventional manual wheelchair, a pair of hand rims are arranged outside of a pair of right and left rear wheels and coaxially connected thereto. When a user rotates the hand rim, the rotational force is transmitted to the wheel to move the wheelchair. In recent years, for the purpose of reducing the burden of moving the hand rim by a user, a power assist system has been developed, in which an appropriate assisting force corresponding to the manual force for moving the hand rim is transmitted to a driving wheel by an electric motor.

According to this system, the manual force for moving the hand rim of the wheelchair and the rotational force of the electric motor output in accordance with the manual force are integrated to rotate the wheels, which enables easy moving of the wheelchair. This kind of power assist system may be applied not only to a wheelchair but also to a power assist bicycle, a power steering device of an automobile, etc.

This kind of power assist system is provided with a detection device for detecting a torque by detecting a relative rotational angular displacement of a pair of rotatory members coaxially arranged with each other in a relatively movable manner. As a device for detecting such a relative rotational angular displacement or a relative rotational torque, Japanese Unexamined Laid-open Patent Application Publication No. 2008-249366 discloses the following device. The device includes a pair of first and second shafts arranged coaxially with each other, a cylindrical magnet fixed to the first shaft, a pair of yoke rings fixed to the second shaft, a pair of magnetic flux inducing rings each arranged so as to surround each yoke ring and each having a magnetic flux inducing projection, and a magnetic sensor arranged between the magnetic flux inducing projections and configured to detect magnetic flux changes occurred in the yoke rings according to the relative angular displacements of the first and second shafts.

In the relative rotational angular displacement detection device, the first shaft is coaxially provided with the cylindrical magnet so as to rotate together with the first shaft. The cylindrical magnet includes magnetic poles, i.e., N-poles and S-poles, magnetized in a radial direction of an axis of rotation and arranged alternately in a circumferential direction of the axis of rotation. The second shaft is provided with the pair of yoke rings which rotate together with the second shaft. Each yoke ring includes triangular shaped ledges corresponding to the N-poles and S-poles.

Each ledge is arranged outside of the cylindrical magnet so as to face the pole of the cylindrical magnet in the radial direction of the axis of rotation. The pair of yoke rings are arranged such that the ledges of one of the yoke rings and the ledges of the other of the yoke rings are arranged so as to oppose in an axial direction of the axis of rotation and arranged alternately in the circumferential direction. A pair of magnetic flux inducing rings each for inducing the magnetic flux generated in each yoke ring are arranged radially outside of the corresponding yoke rings.

When the first shaft and the second shaft are relatively rotated, the relative position of each yoke ring with respect to the magnetic pole of the cylindrical magnet is changed. This causes magnetic flux changes between the magnetic flux inducing rings. The magnetic flux changes are detected by the magnetic sensor.

### SUMMARY OF THE INVENTION

In the aforementioned detection device, the pair of yoke rings are provided so as to rotate together with the second shaft. On the other hand, the two magnetic flux inducing rings are fixed to the housing. In other words, the pair of yoke rings are structured so as to be relatively rotated with respect to the two magnetic flux inducing rings. For this reason, in order to detect the changes of the magnetic flux with a high degree of accuracy, the pair of yoke rings and the two annular magnetic flux inducing rings are formed into an annular shape, respectively, and arranged in the radial direction of the axis of rotation with a gap therebetween. However, since both members are formed into an annular shape, respectively, and the accuracy of the gap is secured, the production cost and the assembly cost of the detection device was high.

The preferred embodiments of the present invention have been developed in view of the above-mentioned and/or other problems in the related art. The preferred embodiments of the present invention can significantly improve upon existing methods and/or apparatuses.

Among other potential advantages, some embodiments can provide a relative rotational angular displacement detection device simple in structure and simple in assembly work and capable of detecting a relative rotational angular displacement of a pair of rotatable members arranged coaxially with each other with a high degree of accuracy.

Among other potential advantages, some embodiments can provide a torque detection device using the relative rotational angular displacement detection device, and a torque control device using the relative rotational angular displacement detection device.

Among other potential advantages, some embodiments can provide a power assist wheelchair, a power assist straddle-type vehicle, and a power steering device equipped with the torque control device.

Other objects and advantages of the present invention will be apparent from the following preferred embodiments.

According to some embodiments of the present invention, a relative rotational angular displacement detection device includes, as main structural members, a pair of rotatable members, a permanent magnet, a magnetic flux inducing ring, and a magnetic detection portion.

The relative rotational angular displacement detection device includes a pair of rotatable members rotatable by 360 degrees or more around an axis of rotation and relatively rotatable in a circumferential direction, and a permanent magnet attached to one of the pair of rotatable members and including magnetic poles arranged so as to change in polarity alternately in the circumferential direction of the axis of rotation.

The relative rotational angular displacement detection device further includes a magnetic flux inducing ring. This magnetic flux inducing ring includes an annular ring body attached to the other of the pair of rotatable members and arranged coaxially with the axis of rotation and a plurality of protrusions protruding from the ring body and arranged at a position facing the magnetic pole in a magnetization direction of the permanent magnet.

The relative rotational angular displacement detection device further includes a magnetic detection portion configured to detect a magnetic flux of the ring body of the magnetic flux inducing ring magnetized depending on a relative position of each protrusion of the magnetic flux inducing ring and each magnetic pole of the permanent magnet.

The magnetic detection portion includes a first facing portion arranged to face a part of the ring body to induce a magnetic flux of the part of the ring body, a second facing portion arranged at a position apart from the first facing portion in a circumferential direction of the axis of rotation to induce a magnetic flux of a part of the ring body, a first magnetic sensor configured to detect the magnetic flux induced by the first facing portion, and a second magnetic sensor configured to detect the magnetic flux induced by the second facing portion. The first facing portion and the second facing portion are fixed in the circumferential direction of the axis of rotation regardless that the permanent magnet and the magnetic flux inducing ring rotate about the axis of rotation.

In some exemplary embodiments of the relative rotational angular displacement detection device, the first facing portion and the second facing portion are arranged at positions where a central angle of the first facing portion and the second facing portion satisfies a relational expression of [an electric angle of the permanent magnet×N+the electric angle/2, where N and M are positive integers].

In this case, in cases where the first and second magnetic sensors are relatively rotated in the circumferential direction with respect to the ring body of the magnetic flux inducing ring in a state in which the magnetic flux inducing ring and the permanent magnet are not relatively rotated, i.e., in a state in which no or less fluctuation of the output from the magnetic detection portion can be expected since the pair of rotatable members are not relatively displaced, when the outputs of both the magnetic sensors are combined, the amplitude of the combined output waveform is reduced as compared with the amplitude of the output waveform of each magnetic sensor. Thus, the output fluctuations from the magnetic sensor portion which may cause erroneous detection can be reduced, resulting in improved detection accuracy.

In some exemplary embodiments of the relative rotational angular displacement detection device, the magnetic detection portion includes M pieces of facing portions including the first facing portion and the second facing portion, and the facing portions are arranged at positions where a central angle of adjacent facing portions satisfies a relational expression of [an electric angle of the permanent magnet×N+the electric angle/(2+M), where N and M are positive integers].

Also in this case, when the first and second magnetic sensors are relatively rotated in the circumferential direction with respect to the ring body of the magnetic flux inducing ring in a state in which the magnetic flux inducing ring and the permanent magnet are not relatively rotated, i.e., in a state in which no or less fluctuation of the output from the magnetic detection portion can be expected since the pair of rotatable members are not relatively displaced, when the outputs of both the magnetic sensors are combined, the amplitude of the combined output waveform is reduced as compared with the amplitude of the output waveform of each magnetic sensor. Thus, the output fluctuations from the magnetic sensor portion which may cause erroneous detection can be reduced, resulting in improved detection accuracy.

In some exemplary embodiments of the relative rotational angular displacement detection device, the magnetic detection portion includes a first intermediate yoke arranged between the first magnetic sensor and the ring body so as to face the ring body, and a second intermediate yoke arranged between the second magnetic sensor and the ring body so as to face the ring body. The first facing portion is provided at the first intermediate yoke, and the second facing portion is provided at the second intermediate yoke.

In some exemplary embodiments of the relative rotational angular displacement detection device, the magnetic detection portion includes the first magnetic sensor configured to receive a magnetic flux induced by the first intermediate yoke, and the second magnetic sensor configured to receive a magnetic flux induced by the second intermediate yoke.

In some exemplary embodiments of the relative rotational angular displacement detection device, the magnetic detection portion includes a first intermediate yoke arranged between the first magnetic sensor and the ring body so as to face the ring body, and a second intermediate yoke arranged between the second magnetic sensor and the ring body so as to face the ring body. The first facing portion is provided at the first intermediate yoke, and the second facing portion is provided at the second intermediate yoke, and the first magnetic sensor is configured to detect a magnetic flux of the first intermediate yoke, and the second magnetic sensor is configured to detect a magnetic flux of the second intermediate yoke.

In some exemplary embodiments of the relative rotational angular displacement detection device, the first facing portion includes a first magnetic flux inducing portion, and the second facing portion includes a second magnetic flux inducing portion. The first magnetic flux inducing portion is a protruded portion protruded in a radially outward direction of the axis of rotation, or a dented portion dented in a radially inward direction of the axis of rotation, and the second magnetic flux inducing portion is a protruded portion protruded in a radially outward direction of the axis of rotation, or a dented portion dented in a radially inward direction of the axis of rotation

In some exemplary embodiments of the relative rotational angular displacement detection device, the first facing portion and the second facing portion are arranged so that a center angle of adjacent first facing portion and second facing portion is ¼ or more of an electric angle of the permanent magnet and ¾ or less of the electric angle.

According to other preferred embodiments of the present invention, a torque detection device is equipped with the relative rotational angular displacement detection device. The torque detection device includes an elastic member arranged between the pair of rotatable members, wherein an urging force is always given to the pair of rotatable members by the elastic member in the relative rotational direction, and the pair of rotatable members are provided with a relative rotation restricting portion which restricts a relative rotation of the pair of rotatable members when one of the pair of rotatable members is relatively rotated with respect to the other of the pair of rotatable members by a certain rotational angle against the urging force of the elastic member.

According to still other preferred embodiments of the present invention, a torque control device is equipped with the relative rotational angular displacement detection device. The torque control device includes a rotary driving member connected to one of the pair of rotatable members, wherein a rotational force is given to the rotary driving member by a user, a power source configured to give a rotational force to the other of the pair of rotatable members, and a control portion configured to control the rotational force given by the power source depending on an output of the magnetic detection portion in a state in which the one of the pair of rotatable members is relatively rotated with respect to the other of the pair of rotatable members by a certain rotational angle.

According to still other preferred embodiments of the present invention, a power assist wheelchair equipped with the torque control device can be provided.

According to still other preferred embodiments of the present invention, a power assist straddle-type vehicle equipped with the torque control device can be provided.

According to still other preferred embodiments of the present invention, a power steering device equipped with the torque control device can be provided.

According to some preferred embodiments of the present invention, the permanent magnet is attached to one of the pair of rotatable members in such a manner that magnetic poles are arranged so as to change in polarity alternately in the circumferential direction of the axis of rotation, and the ring body of the magnetic flux inducing ring is attached to the other of the pair of rotatable members so that a plurality of protrusions protruding from the ring body are arranged at positions facing the magnetic pole of the permanent magnet. Therefore, the protrusion of the magnetic flux inducing ring can be formed into a simple shape, which in turn can form the protrusion with a high degree of accuracy. Furthermore, since the protrusions of the magnetic flux inducing ring are arranged at positions facing the magnetic poles in the magnetization direction of the permanent magnet, the relative position of the protrusion with respect to the permanent magnet can be determined only by the distance in the axial direction, which enables high accuracy assembling. Therefore, although the relative rotational angular displacement detection device is simple in structure and simple in assembly, the relative rotational angular displacement of the pair of rotatable members which are relatively rotatable can be detected with a high degree of accuracy.

In the relative rotational angular displacement detection device, the magnetic flux of the ring body of the magnetic flux inducing ring magnetized depending on the relative position of each protrusion of the magnetic flux inducing ring and each magnetic pole of the permanent magnet is detected by the magnetic detection portion. This reduces the number of component parts and simplifies the structure. Since the structure is simple, the production and assembly can also be performed easily with a high degree of accuracy.

The magnetic detection portion includes a first facing portion arranged to face a part of the ring body to induce a magnetic flux of a part of the ring body, a second facing portion arranged at a position apart from the first facing portion in a circumferential direction of the axis of rotation to induce a magnetic flux of a part of the ring body, a first magnetic sensor configured to detect the magnetic flux induced by the first facing portion, and a second magnetic sensor configured to detect the magnetic flux induced by the second facing portion. This reduces the number of component parts and simplifies the structure. Since the structure is simple, the production and assembly can also be performed easily with a high degree of accuracy.

Further, the first facing portion and the second facing portion are fixed in the circumferential direction of the axis of rotation regardless that the permanent magnet and the magnetic flux inducing ring rotate about the axis of rotation. Therefore, the magnetic sensors can be arranged on a non-rotatable side such as a vehicle body, which simplifies the mounting structure and reduced the risk of malfunctions.

By arranging the first facing portion and the second facing portion at positions where a central angle of the first facing portion and the second facing portion satisfies a relational expression of [an electric angle of the permanent magnet×N+the electric angle/2, where N is a positive integers], or in cases where the magnetic detection portion includes M pieces of facing portions includes the first facing portion and the second facing portion, by arranging the facing portions at positions where a central angle of adjacent facing portions satisfies a relational expression of [an electric angle of the permanent magnet×N+the electric angle/(2+M), where N and M are positive integers], in cases where the first and second magnetic sensors are relatively rotated in the circumferential direction with respect to the ring body of the magnetic flux inducing ring in a state in which the magnetic flux inducing ring and the permanent magnet are not relatively rotated, i.e., in a state in which no or less fluctuation of the output from the magnetic detection portion can be expected since the pair of rotatable members are not relatively displaced, when the outputs of both the magnetic sensors are combined, the amplitude of the combined output waveform is reduced as compared with the amplitude of the output waveform of each magnetic sensor. Thus, the output fluctuations from the magnetic sensor portion which may cause erroneous detection can be reduced, resulting in improved detection accuracy.

### BRIEF EXPLANATION OF THE DRAWINGS

The preferred embodiments of the present invention are shown by way of example, and not limitation, in the accompanying figures, in which:

FIG. 1 is an explanatory view showing a schematic structure of a relative rotational angular displacement detection device according to some exemplary embodiments of the present invention;

FIG. 2 is an enlarged cross-sectional view showing a portion “A” surrounded by a dash line in FIG. 1;

FIG. 3 is a schematic structural view of the aforementioned device as seen in an axial direction of the axis of rotation;

FIG. 4A is an explanatory view showing a relative positional relation of magnetic poles of the permanent magnet, protrusions of the magnetic flux inducing ring, and the magnetic detection portion;

FIG. 4B is a graph showing a waveform of an output of the first magnetic sensor, a waveform of an output of the second magnetic sensor, and a combined waveform obtained by combining these waveforms when the magnetic detection portion is rotated in the circumferential direction along the ring body of the magnetic flux inducing ring while maintaining the relative positional relation of the protrusion and the magnetic detection portion to the state shown in FIG. 3;

FIG. 5A is an explanatory view showing a relative positional relation of the magnetic poles, the protrusion of the magnetic flux inducing ring and the magnetic detection portion according to some exemplary embodiments of the present invention;

FIG. 5B a graph showing a waveform of an output of the first magnetic sensor, a waveform of an output of the second magnetic sensor, and a combined waveform obtained by combining these waveforms when the magnetic detection portion is rotated in the circumferential direction along the ring body of the magnetic flux inducing ring while maintaining the relative positional relation of the protrusion and the magnetic detection portion to the initial state;

FIG. 6 is a plan view of an intermediate yoke used in some exemplary embodiments;

FIG. 7A is an explanatory view showing the relative positional relation of the magnetic poles and the protrusions of the magnetic flux inducing ring in the initial state;

FIG. 7B is an explanatory view showing the relative positional relation of the magnetic poles and the protrusions of the magnetic flux inducing ring in a state in which the first and second rotatable members are rotated by a certain angle from the initial state;

FIG. 8A is an explanatory view showing the magnetic flux distribution state of the magnetic poles and the protrusions of the magnetic flux inducing ring in the initial state,

FIG. 8B is an explanatory view showing the magnetic flux distribution state of the permanent magnet, the magnetic flux inducing ring, the intermediate yoke, the magnetic sensor and the back yoke in the initial state;

FIG. 8C is an explanatory view showing the magnetic flux distribution state of the permanent magnet, the magnetic flux inducing ring, the intermediate yoke, the magnetic sensor and the back yoke and the vicinity thereof in the initial state;

FIG. 9A is an explanatory view showing the magnetic flux distribution state of the magnetic poles of the permanent magnet and the magnetic flux inducing ring in the state in which the first and second rotatable members are rotated by a certain angle from the initial state;

FIG. 9B is an explanatory view showing the magnetic flux distribution state of the permanent magnet, the magnetic flux inducing ring, the intermediate yoke, the magnetic sensor and the back yoke in the state in which the first and second rotatable members are rotated by a certain angle from the initial state;

FIG. 9C is an explanatory view showing the magnetic flux distribution state of the permanent magnet, the magnetic flux inducing ring, the intermediate yoke, the magnetic sensor and the back yoke and the vicinity thereof in the state in which the first and second rotatable members are rotated by a certain angle from the initial state;

FIG. 10 is an explanatory view showing a power assist wheelchair to which the torque control device using the relative rotational angular displacement detection device according to the present invention is applied;

FIG. 11 is an explanatory view showing a power assist bicycle to which the torque control device using the relative rotational angular displacement detection device according to the present invention is applied; and

FIG. 12 is a schematic explanatory view showing a power assist system in a vehicle power steering device to which the torque control device using the relative rotational angular displacement detection device according to the present invention is applied.

### DETAILED DESCRIPTION OF THE PREFERRED EMBODIMENTS

In the following paragraphs, some preferred embodiments of the present invention will be described with reference to the attached drawings by way of example and not limitation. It should be understood based on this disclosure that various other modifications can be made by those in the art based on these illustrated embodiments.

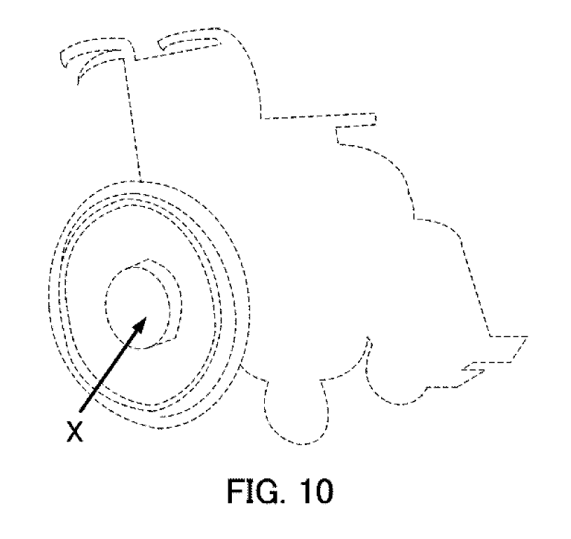

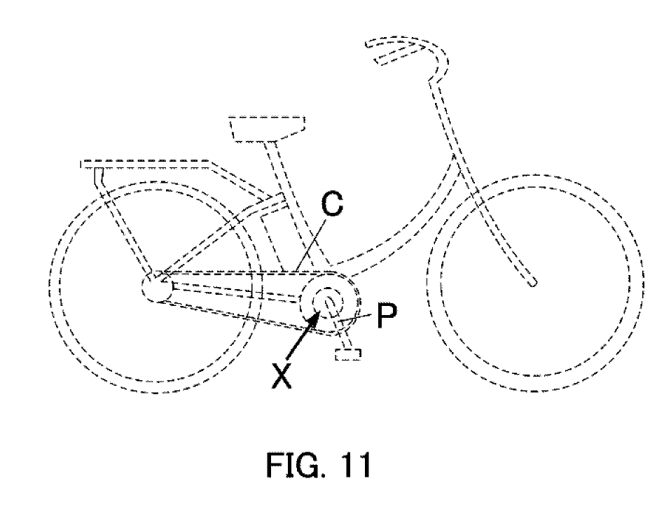

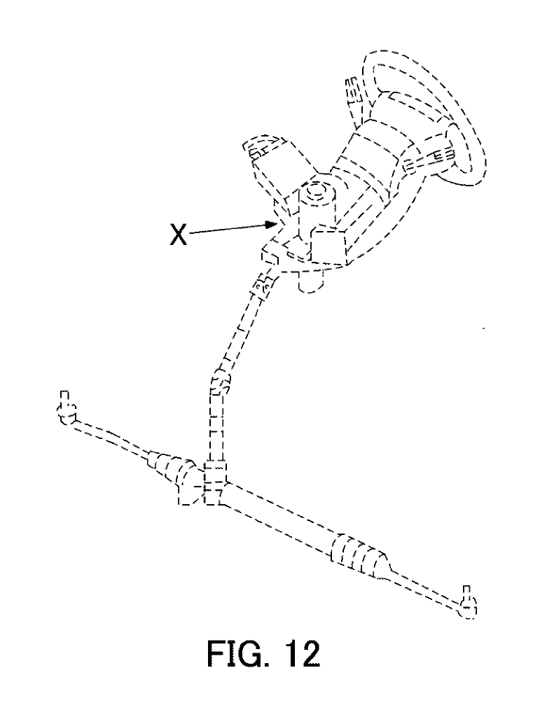

Hereinafter, an embodiment of the present invention in which a relative rotational angular displacement detection device X according to the present invention is applied to a power assist system for a power assist wheelchair (see FIG. 10) will be explained with reference to the attached drawings. Needless to say, the relative rotational angular displacement detection device according to the present invention is not limited to the case in which the device is used in a power assist system for a power assist wheelchair, and can also be applied to various devices and mechanisms for detecting a relative rotational angular displacement of a pair of rotatable members which are movable relatively. For example, the present invention can also be preferably applied to, e.g., a power assist system for a power assist bicycle (see FIG. 11), a power steering device for an automobile (see FIG. 12), etc.

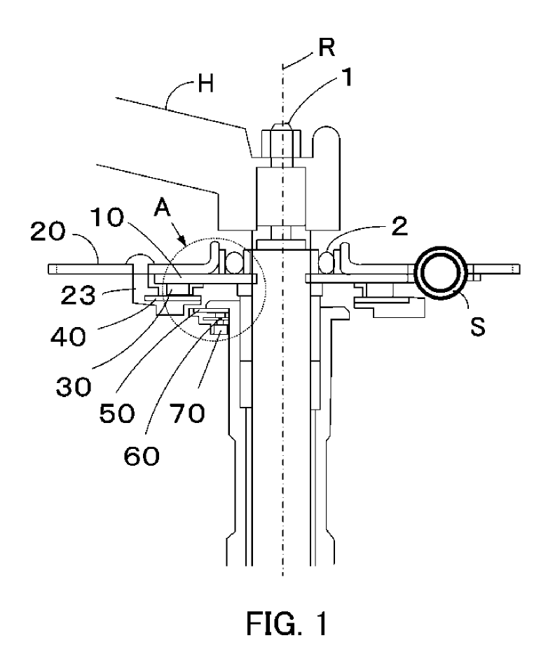

As shown in FIG. 1, in the relative rotational angular displacement device X according to the embodiment, a hand rim H is attached to one end of a shaft 1. A lever member 10 as a first rotatable member and a sprocket 20 as a second rotatable member are arranged coaxially with the shaft 1. As shown in this figure, the lever member 10 and the sprocket 20 are arranged closely with each other in an adjacent manner so as to be relatively rotatable in the circumferential direction of an axis R of rotation.

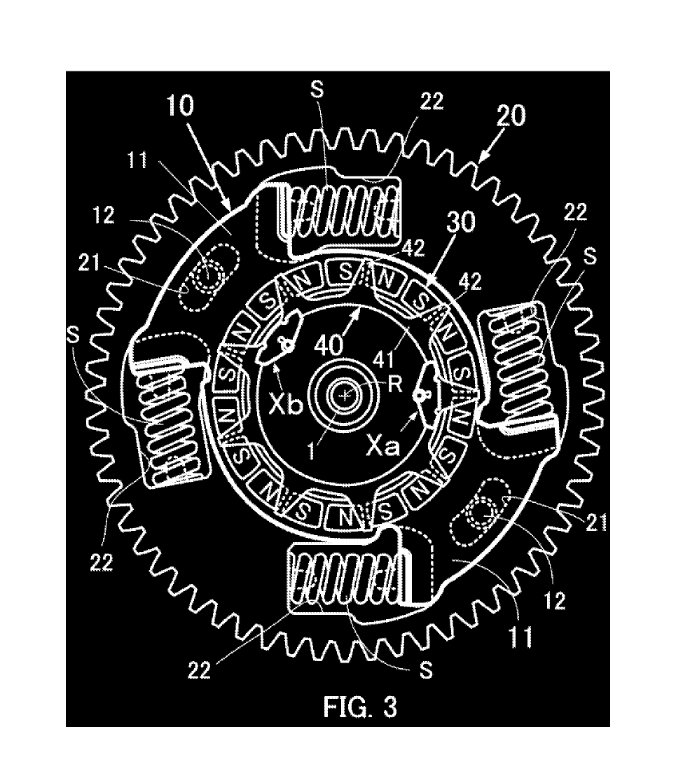

As shown in FIG. 3, the lever member 10 as a first rotatable member is integrally provided with two engaging portions 11 arranged at 180 degrees phase difference and each extending radially outward of the shaft 1, and is configured to rotate together with the shaft 1 in accordance with the rotation of the hand rim H. On the other hand, as shown in FIG. 1, the sprocket 20 as a second rotatable member is arranged coaxially with the shaft 1 via a bearing 2 in a relatively rotatable manner with respect to the lever member 10 as a first rotatable member.

As shown in FIG. 3, each engaging portion 11 of the lever member 10 is provided with an engaging protrusion 12 protruded in an axially outward direction, i.e., protruded toward the sprocket 20. Each protrusion 12 is fitted in an arc-shaped slit 21 formed in the sprocket 20, the slit 21 extending in the circumferential direction. This engaging protrusion 12 is slidably movable within a length range extending in the circumferential direction of the slit 21 in accordance with the rotational movement of the lever member 10.

In the sprocket 20, spring mounting holes 22 each for mounting a coil spring S as an elastic member are formed at four circumferential portions. In each spring mounting hole 22, a coil spring S is mounted. Each engaging portion 11 of the lever member 10 is arranged between a pair of coil springs S arranged in the circumferential direction and engaged with the end portions of the coil springs S. In this engaged state, each engaging portion 11 is urged by both the coil springs S in both directions, i.e., the clockwise direction and the counterclockwise direction.

Therefore, in a state in which no external force is applied, the lever member 10 remains stationary at a position where urging forces of the pair of coil springs S are balanced. Thus, the lever member 10 is in a state in which the lever member 10 rotates in either clockwise direction or counterclockwise direction when a force is applied in the circumferential direction.

In a state in which no external force (rotational force) is applied, each engaging protrusion 12 provided at each engaging portion 11 of the lever member 10 is positioned at a longitudinal intermediate portion of the corresponding slit 21 formed in the sprocket 20 as shown in FIG. 3. From this state, when a rotational force is applied to the hand rim H in a clockwise direction or in a counterclockwise direction, the shaft 1 fixed to the hand rim H rotates. In accordance with the rotation of the hand rim H, the rotational force is given to the lever member 10 fixed to the shaft 1, resulting in a rotation of the lever member 10 in the clockwise direction or in the counterclockwise direction.

When the lever member 10 rotates, the engaging portion 11 rotates relative to the sprocket 20 while pushing against the urging force of the spring S mounted at a rotational direction side. At this time, the engaging protrusion 12 provided at the engaging portion 11 of the lever member 10 moves in the circumferential direction (in the clockwise direction or in the counterclockwise direction) in the slit 21 formed in the sprocket 20. When the engaging protrusion 12 provided at the engaging portion 11 of the lever member 10 reaches a circumferential end of the slit 21, the engaging protrusion 12 is engaged with the circumferential end of the slit 21. Therefore, the sprocket 20 thereafter rotates together with the lever member 10 in accordance with the rotation of the lever member 10. Even until the engaging protrusion 12 reaches the circumferential end of the slit 21, the sprocket 20 rotates by the urging force of the spring S.

As explained above, in this embodiment, the lever member 10 as a first rotatable member and the sprocket 20 as a second rotatable member are relatively movable within a certain range in the circumferential direction of the shaft 1, i.e., within a length range in the circumferential direction of the slit 21 formed in the sprocket 20. By detecting the relative rotational angular displacement of the rotatable members 10 and 20 within the limited relative rotational range in the circumferential direction, in other words, the relative rotational torque, an electric motor (not illustrated) is controlled, so that a rotational force given from an outside and a rotational force of the electric motor output in accordance with the rotational force are combined to thereby control a rotational force of the sprocket S.

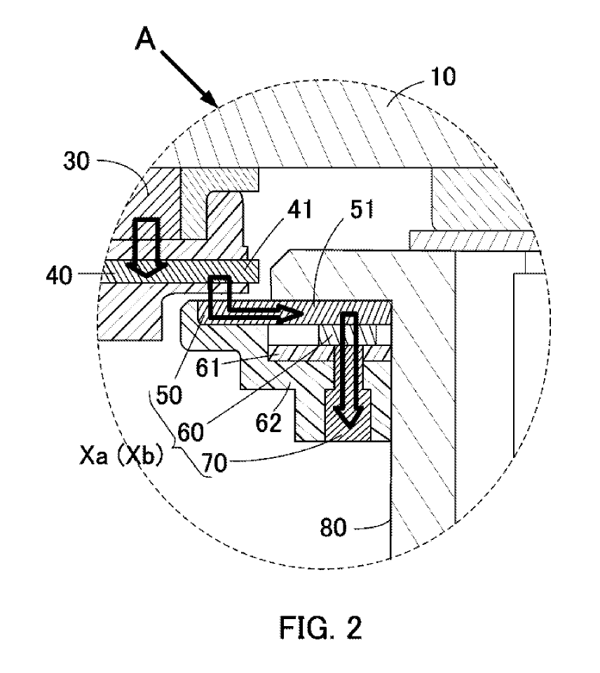

In order to detect the relative rotational angular displacement of the lever member 10 as a first rotatable member and the sprocket 20 as a second rotatable member, in this embodiment, as shown in FIG. 3, the device includes a permanent magnet 30, a magnetic flux inducing ring 40, and two magnetic sensing devices (magnetic detection portion) Xa and Xb. Each magnetic sensing device Xa and Xb includes, as main structural members, an intermediate yoke 50, a magnetic sensor 60 and a back yoke 70 as shown in FIG. 2.

The permanent magnet 30 is an annular or ring-shaped magnet arranged coaxially with the shaft 1 as shown in FIG. 3, in which the magnetic poles, i.e., N-poles and S-poles, are arranged alternately in the circumferential direction of the shaft 1. Each magnetic pole is magnetized in the axial direction of the shaft 1, i.e., in a direction parallel to the axial direction of the axis R of rotation.

In this embodiment, nine pairs of magnetic poles (a total of 18 magnetic poles, nine S-poles and nine N-poles) are arranged at equal intervals in the circumferential direction. This annular or ring-shaped permanent magnet 30 is arranged coaxially with the lever member 10 and fixed to the lever member 10, so that the permanent magnet 30 rotates together with the rotation of the lever member 10. It should be noted, however, that in the present invention the permanent magnet 30 is not limited to the aforementioned annular or ring-shaped permanent magnet, but can be constituted by a plurality of separate permanent magnets arranged at equal intervals in the circumferential direction. Further, the permanent magnet 30 can be either a sintered magnet or a bond magnet, and also can be either an isotropic magnet or an anisotropic magnet. Further, the permanent magnet 30 can be a polar anisotropic magnet.

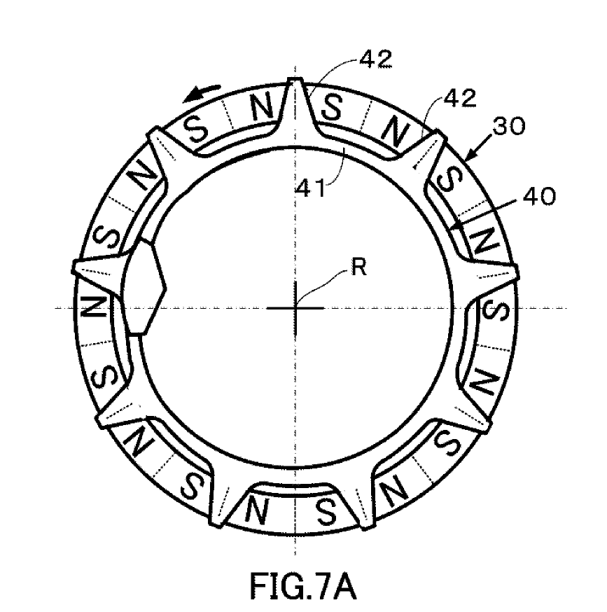

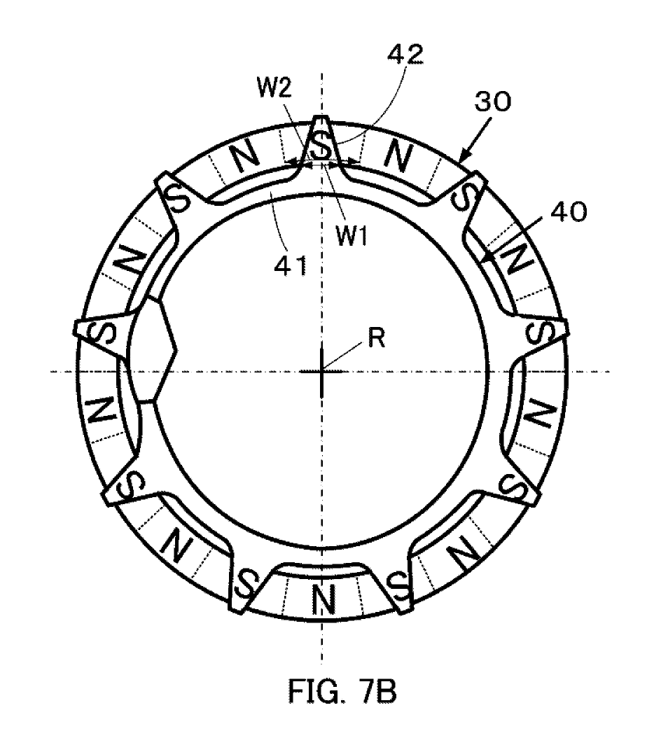

The magnetic flux inducing ring 40 is, as shown in FIGS. 1 to 3, arranged coaxially with the sprocket 20. The magnetic flux inducing ring 40 includes an annular ring body 41 and a plurality of protrusions 42 protruded in a radially outward direction from the outer peripheral edge of the ring body 41. The ring body 41 is arranged so as not to overlap the permanent magnet 30 in the radial direction of the shaft 1. In other words, the ring body 41 is arranged so as not to overlap the permanent magnet 30 when seen in the axial direction of the shaft 1. The plurality of protrusions 42 are arranged so as to overlap the permanent magnet 30 in the radial direction. In other words, the plurality of protrusions 42 overlaps the permanent magnet 30 when seen in the axial direction of the shaft 1. The number of protrusions 42 (nine protrusions in this embodiment) is equal to the number of pairs of magnetic poles of the permanent magnet 30. Each protrusion 42 has a circumferential width W1 smaller than a circumferential width W2 of each magnetic pole as shown in FIG. 7B.

More specifically, each protrusion 42 of the magnetic flux inducing ring 40 is formed into a tapered triangular shape or a trapezoidal shape with the width decreasing toward the radially outward direction. The circumferential width W1 of a portion of the protrusion 42 overlapping the inner peripheral edge of the permanent magnet 30 when seen from the axial direction of the shaft 1 is set to be narrower than the circumferential width W2 of the inner peripheral edge of each magnetic pole. As shown in FIG. 1, this magnetic flux inducing ring 40 is integrally secured to the sprocket 20 via an attachment 23 in a state in which the ring 40 is detached from the sprocket 20 in the axial direction. That is, the magnetic flux inducing ring 40 is configured to integrally rotate with the sprocket 20.

In this embodiment, it is exemplified that each protrusion 42 of the magnetic flux inducing ring 40 extends in a radially outward direction. However, the protrusion 42 of the magnetic flux inducing ring 40 is not limited to it. For example, the protrusion 42 of the magnetic flux inducing ring 40 can be a protrusion extending in a radially inward direction. That is, it can be configured such that the ring body 41 is arranged radially outward of the annular permanent magnet 30 and the protrusions 42 extend from the ring body 41 in a radially inward direction.

The magnetic flux inducing ring 40 can be preferably produced by punching a steel plate, etc., but the magnetic flux inducing ring 40 can be constituted by combining a plurality of members. Further, in this embodiment, it is exemplified that the magnetic flux inducing ring 40 includes the ring body 41 and protrusions 42 that are formed on the same plane, but not limited to it. For example, the protrusion 42 can be formed into a shape bent at a certain angle with respect to the ring body 41.

Each protrusion 42 of the magnetic flux inducing ring 40 is positioned in between the S-pole and the N-pole of the permanent magnet 30 in an initial state in which no external force is applied to the shaft 1 as shown in FIG. 3. When an external force is applied to the shaft 1 from the initial state, the lever member 10 rotates in either clockwise direction or counterclockwise direction in accordance with the direction of the external force. In accordance with the rotation, the lever member 10 is relatively displaced with respect to the sprocket 20.

At this time, the engaging protrusion 12 provided at the engaging portion 11 of the lever member 10 moves along the slit 21 formed in the sprocket 20. The engaging protrusion 12 of the lever member 10 moves along the slit 21 until the engaging protrusion 12 is engaged with the circumferential end of the slit 21 and the further relative movement of the engaging protrusion 12 is limited. In a state in which the engaging protrusion 12 of the lever member 10 is moved and engaged with the circumferential end of the slit 21, all of the protrusions 42 of the magnetic flux inducing ring 40 are positioned so that the area of the protrusion 42 overlapping one of magnetic poles (e.g., S-pole) of the permanent magnet 30 becomes large.

The intermediate yoke 50 is arranged close to the magnetic flux inducing ring 40 via a certain gap so that the intermediate yoke 50 overlaps the ring body 41 of the magnetic flux inducing ring 40 in the radial direction of the shaft 1, i.e., the intermediate yoke 50 overlaps the ring body 41 when seen in the axial direction of the shaft 1. This intermediate yoke 50 is made of a ferromagnetic substance, such as, e.g., iron, and configured to induce the magnetic flux of the magnetic flux inducing ring 40 magnetized by the permanent magnet 30 and also to decrease the electric angular amplitude of the magnetic flux of the magnetic flux inducing ring 40.

The magnetic sensor 60 is an element for detecting the magnetic flux passing through the intermediate yoke 50 and is arranged to overlap the intermediate yoke 50 in the radial direction, i.e., arranged to overlap the intermediate yoke 50 when seen in the axial direction of the shaft 1 as shown in FIGS. 1 and 2. As the magnetic sensor 60, for example, a Hall element (Hall IC) can be preferably used. As shown in FIG. 2, the magnetic sensor 60 may be attached to a resin base plate 61 and fixed to a vehicle side non-rotatable member 80 via a base plate holder 62.

The back yoke 70 is made of a ferromagnetic substance, such as, e.g., iron, and is integrally embedded in the base plate holder 62. This back yoke 70 is arranged adjacent to the magnetic sensor 60 in a manner such that the back yoke 70 overlaps the magnetic sensor 60 in the radial direction, i.e., the back yoke 70 overlaps the magnetic sensor 60 when seen in the axial direction of the shaft 1.

In detail, the intermediate yoke 50, the magnetic sensor 60, and the back yoke 70 are integrated so as to overlap with each other when seen in the axial direction of the shaft 1, and constitute a magnetic flux inducing path as a part of a magnetic path of the magnetic flux of the magnetic flux inducing ring 40 magnetized by the permanent magnet 30. As explained above, although the magnetic flux inducing path is formed by the intermediate yoke 50, the magnetic sensor 60, and the back yoke 70, the magnetic path of the permanent magnet 30 is not constituted such that the entire magnetic path from one of the magnetic pole to the other thereof positively constitutes a magnetic closed loop circuit small in magnetic resistance.

In other words, it is constituted as if the magnetic circuit terminates at the back yoke 70. By employing such structure, it is possible to detect the changes of the magnetic flux passing between the intermediate yoke 50 and the back yoke 70 with no practical issues while simplifying the structure of the entire device. Needless to say, it is acceptable that a magnetic closed loop circuit is eventually formed by, example, a vehicle side structural part, such as, e.g., the shaft 1.

Further, in this embodiment, as explained above, the intermediate yoke 50, the magnetic sensor 60 and the back yoke 70 are fixed to the vehicle side non-rotatable member 80, independently of the lever member 10 as a first rotatable member and the sprocket 20 as a second rotatable member. This further simplifies the mounting structure. Furthermore, the magnetic sensor side structure is non-rotatable, which causes less problems.

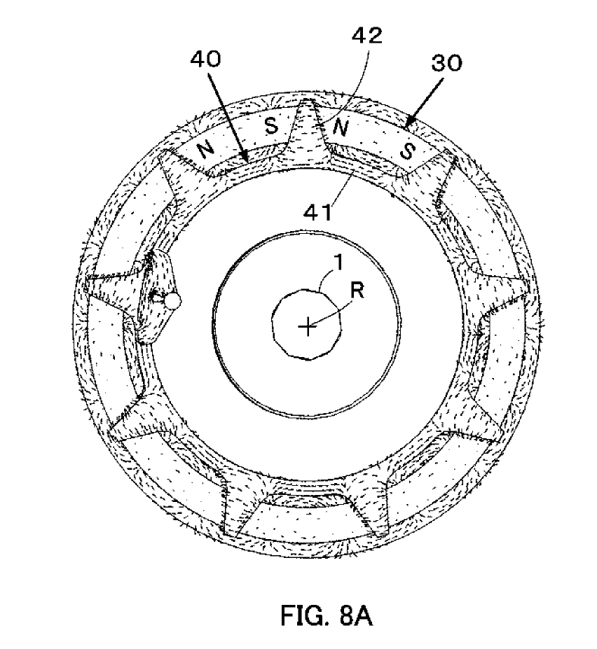

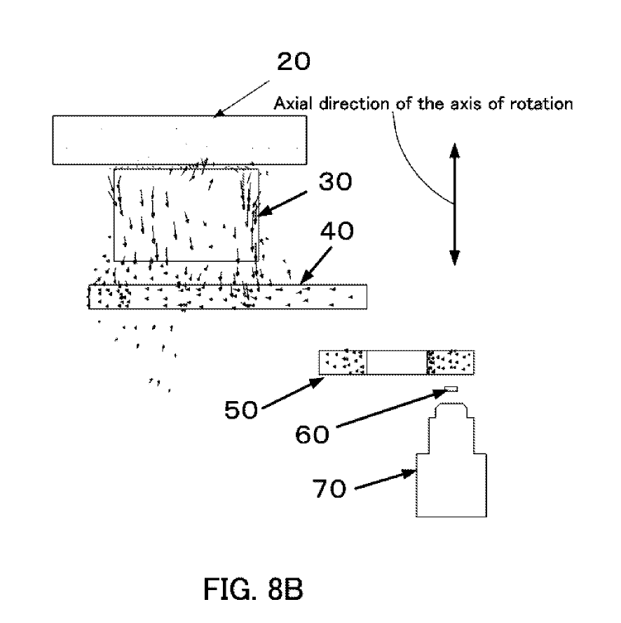

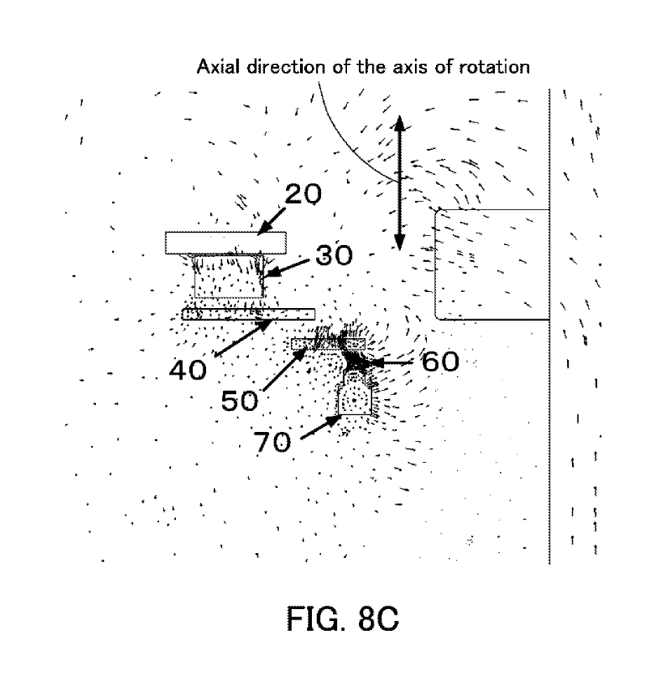

Next, the operating principle of the relative rotational angular displacement detection device of this embodiment will be explained with reference to FIGS. 7 to 9. In these figures, for the explanatory convenience, they illustrate a single magnetic sensing device (magnetic detection portion). FIG. 7A shows an initial state in which the lever member 10 as a first rotatable member and the sprocket 20 as a second rotatable member are not relatively rotated. In this initial state, each protrusion 42 of the magnetic flux inducing ring 40 is positioned at an intermediate position of the adjacent magnetic poles of the permanent magnet 30, i.e., positioned between the N-pole and the S-pole. In this initial state, as shown in FIG. 8A, each protrusion 42 constitutes a magnetic path of the adjacent N-pole and S-pole.

In the initial state, when seen in the axial direction of the shaft 1, the ring body 41 is positioned such that each protrusion 42 is positioned between the N-pole and the S-pole and that the overlapping area of the S-pole and the protrusion 42 and the overlapping area of the N-pole and the protrusion 42 are equal. Therefore, the ring body 41 is weakly magnetized to N-poles and S-poles of the permanent magnet 30 alternately in the circumferential direction. In other words, the ring body 41 is maintaining a so-called magnetically neutral state or almost neutral state (see FIG. 8A).

In the illustrative embodiment, the outer peripheral edge of the ring body 41 and the inner peripheral edge of the permanent magnet 30 are set to have a narrow gap therebetween. Therefore, as explained above, although the ring body 41 is weakly magnetized to N-poles and the S-poles alternately in the circumferential direction corresponding to the N-poles and the S-poles of the permanent magnet 30 or almost not magnetized, by increasing the gap, the magnetization state of the ring body 41 becomes further weak, which results in further improved detection accuracy.

Accordingly, in this initial state, the magnetic flux from the ring body 41 of the magnetic flux inducing ring 40 to the intermediate yoke 50 is very weak, or almost no magnetic flux exists between the magnetic flux inducing ring 40 and the intermediate yoke 50 (see FIGS. 8B and 8C). In this initial state, the magnetic flux of the ring body 41 of the magnetic flux inducing ring 40 weakly magnetized to N-poles and S-poles alternately in the circumferential direction is induced by the intermediate yoke 50 and the back yoke 70 which are arranged adjacent to the ring body 41 of the magnetic flux inducing ring 40 and intensively flows through the magnetic sensor 60 arranged between the intermediate yoke 50 and the back yoke 70 (see FIG. 8C). Accordingly, the magnetic sensor 60 can assuredly detect the magnetic flux of the ring body 41 of the magnetic flux inducing ring 40.

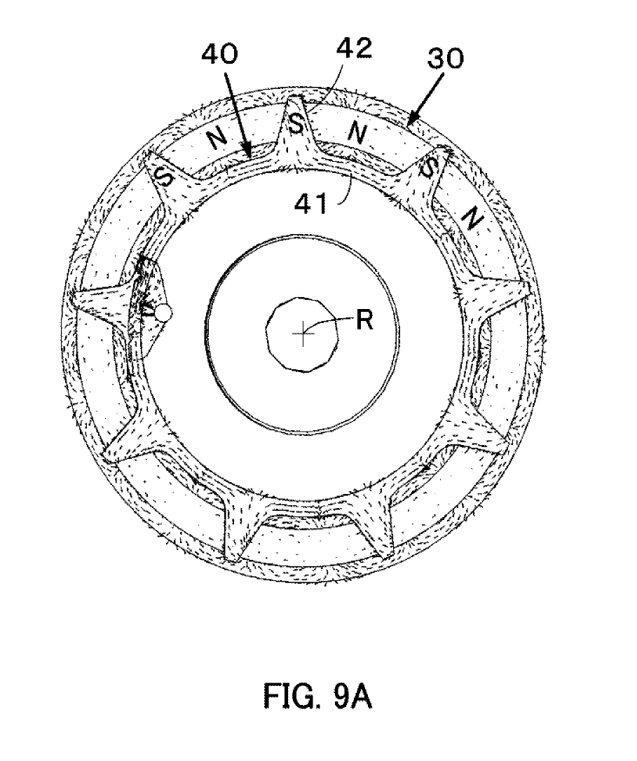

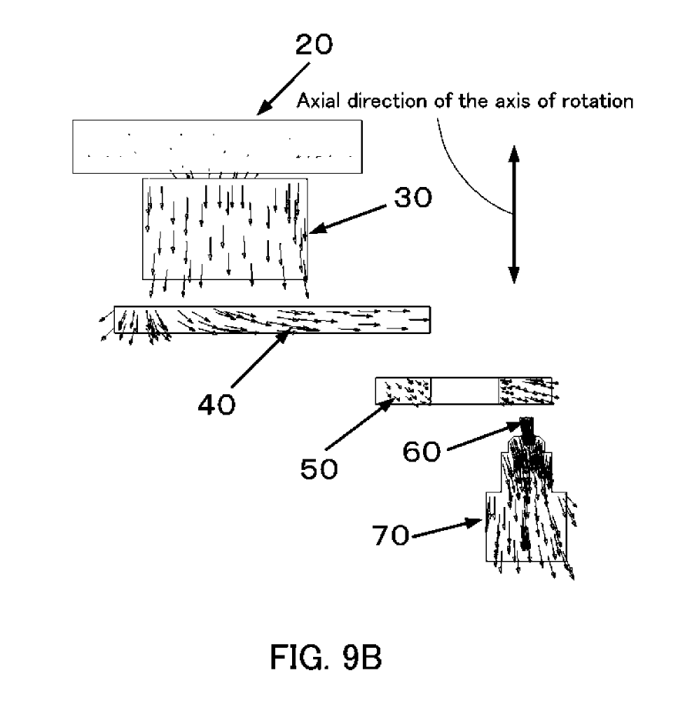

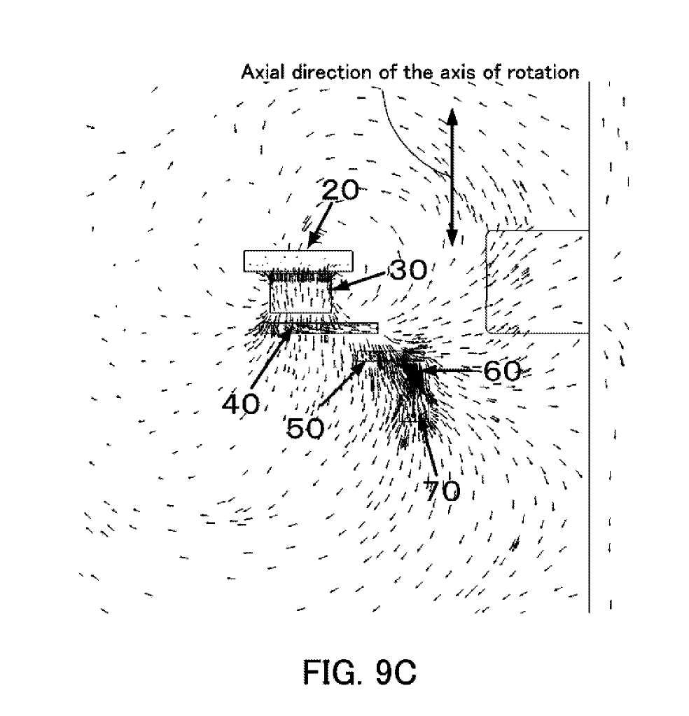

On the other hand, from the aforementioned initial state, when the lever member 10 rotates by a certain angle (10 degrees in this embodiment) in the circumferential direction and each protrusion 42 of the magnetic flux inducing ring 40 overlaps one of magnetic poles (S-pole in this embodiment) of the permanent magnet 30 when seen in the axial direction, the protrusion 42 is strongly magnetized to the overlapping magnetic pole (S-pole in this embodiment) (see FIG. 9A). As a result, the ring body 41 of the magnetic flux inducing ring 40 is magnetized to the overlapping magnetic pole (S-pole in this embodiment) of the permanent magnet 30 along the entire circumference.

Accordingly, the magnet flux of the magnetic flux inducing ring 40 magnetized as mentioned above is induced by the intermediate yoke 50 and the back yoke 70 which are arranged adjacent to the magnetic flux inducing ring 40 and intensively flows through the magnetic sensor 60 arranged between the intermediate yoke 50 and the back yoke 70 (see FIGS. 9B and 9C). As a result, the magnetic sensor 60 can assuredly detect the magnetic flux of the ring body 41 of the magnetic flux inducing ring 40 magnetized to one of magnetic poles (S-pole in this embodiment) along the circumferential direction.

As will be understood from the above, by forming the magnetic flux inducing circuit only by the intermediate yoke 50 and the back yoke 70, without positively forming a magnetic closed loop circuit, the displacement of the magnetic flux passing through the magnetic flux inducing circuit can be detected by the magnetic sensor 60 in a practically satisfactory manner. As shown in FIGS. 8C and 9C, also in this device, although the permanent magnet 30 forms a magnetic closed loop circuit via the magnetic flux inducing ring 40, the intermediate yoke 50 and the back yoke 70, it is not always required to positively form a magnetic closed loop circuit using members other than the aforementioned members.

The phrase “it is not always required to positively form a magnetic closed loop circuit” means that it is sufficient to positively form a magnetic flux inducing circuit by at least the magnetic flux inducing ring 40, the intermediate yoke 50 and the back yoke 70. In other words, in the present invention, it is not intended to exclude the case in which other vehicle constitutional members, such as, e.g., a shaft 1 or peripheral members thereof, eventually form a magnetic closed loop circuit together with the magnetic flux inducing ring 40, the intermediate yoke 50, and the back yoke 70. It should be understood that the present invention does not always require to positively form a magnetic closed loop circuit.

When the permanent magnet 30 rotates in the counterclockwise direction with respect to the magnetic flux inducing ring 40 from the state in which the protrusion 42 of the magnetic flux inducing ring 40 is positioned between the S-pole and the N-pole of the permanent magnet 30, the magnetization state of the ring body 41 of the magnetic flux inducing ring 40 gradually changes from the so-called magnetically neutral or almost neutral state in which the ring body 41 of the magnetic flux inducing ring 40 is weakly magnetized along the entire circumference to the state in which the entire ring body 41 is magnetized to the S-pole. The magnetic sensor 60 detects the change of the magnetic flux depending on the relative rotational angular displacement of the magnetic flux inducing ring 40 with respect to the permanent magnet 30.

Therefore, depending on the change of the detected magnetic flux, the relative rotational angular displacement is continuously detected. In this embodiment, since the spring S is mounted, the relative rotational angular displacement of the lever member 10 and the sprocket 20 can be detected, which in turn can detect the relative rotational torque displacement. Therefore, by controlling a power driving means (not illustrated) with a controller (not illustrated) based on the displacement, the rotational force of the shaft 1 can be assisted.

As explained above, the magnetization state of the ring body 41 of the magnetic flux inducing ring 40 caused by the magnetic poles of the permanent magnet 30 due to the relative rotational angular displacement of the rotatable members 10 and 20 is detected by the magnetic sensor 60, which in turn can detect the relative rotational angular displacement of the pair of rotational members. In order to perform the detection with a higher degree of accuracy, in the relative rotational angular displacement device according to this embodiment of the present invention, as shown in FIG. 3, the device is provided with two magnetic sensing devices Xa and Xb each including the intermediate yoke 50, the magnetic sensor 60 and the back yoke 70.

The reasons for providing two magnetic sensing devices Xa and Xb are as follows. That is, in the initial state shown in FIG. 3, i.e., in the state in which the protrusion 42 of the magnetic flux inducing ring 40 is positioned between the S-pole and the N-pole, as mentioned above, the ring body 41 of the magnetic flux inducing ring 40 is maintaining the state in which the ring body 41 is weakly magnetized alternately in the circumference direction corresponding to the S-pole and the N-pole of the permanent magnet 30. In other words, in the initial state, the ring body 41 is maintaining a so-called magnetically neutral state. However, the ring body 41 is not completely magnetically neutral, but is slightly magnetized so as to alternately change in polarity in the circumferential direction by the influence of each magnetic pole of the permanent magnet 30. Furthermore, it is designed that the permanent magnet 30 and the magnetic flux inducing ring 40 are arranged coaxially with each other. In an actual product, however, there is a case in which the permanent magnet 30 and the magnetic flux inducing ring 40 are not arranged completely coaxially with each other but slightly shifted with each other. In such a case, the gap between the inner peripheral edge of the permanent magnet 30 and the outer peripheral edge of the ring body 41 of the magnetic flux inducing ring 40 slightly differs in the circumferential direction. Furthermore, there is a possibility that the magnetization state of the permanent magnet 30 is not always as designed.

Accordingly, when the magnetic sensing device is moved relative to the ring body 41 of the magnetic flux inducing ring 40 in the circumferential direction in a state in which the relative position of the pair of rotatable members are maintained (e.g., in the initial state), the output of the magnetic sensor 60 may sometimes fluctuate. In this case, since the pair of rotatable members are not relatively rotated, such output fluctuations are not preferable.

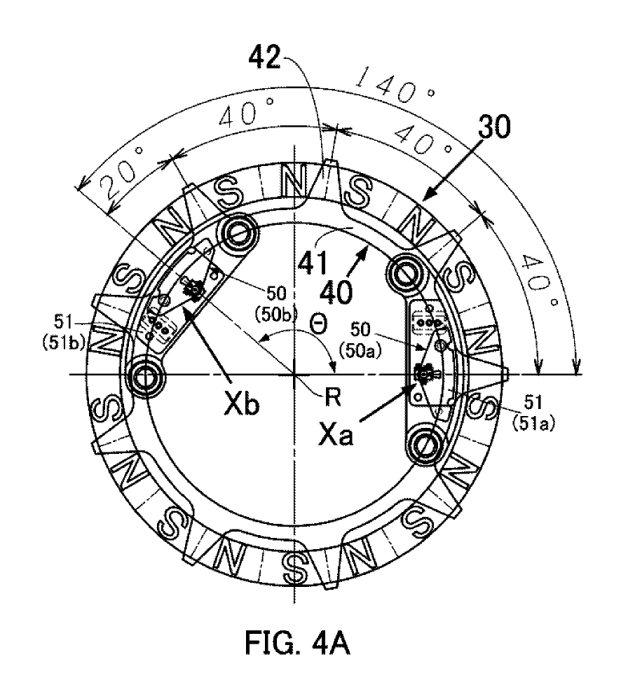

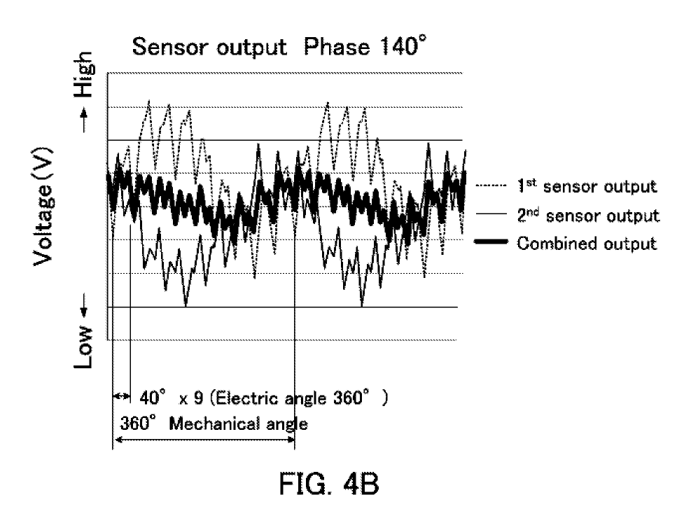

Although it is, of course, possible to control the output fluctuation of the magnetic sensor 60 by software, etc., the present invention solves the aforementioned problem by mechanical structure. FIG. 4B shows output waveforms of the magnetic sensor. As apparent from this graph, the output of the magnetic sensor fluctuates largely and periodically with small fluctuations. The small fluctuations are caused by the ring body 41 of the magnetic flux inducing ring 40 slightly magnetized so as to change in polarity in the circumferential direction. On the other hand, it is thought that the large fluctuations are caused by mechanical errors, such as, e.g., the misalignment of the permanent magnet 30 and the ring body 41 of the magnetic flux inducing ring 40.

Accordingly, in the device of the some exemplary embodiments, as shown in FIG. 3, two magnetic sensing devices Xa and Xb constituted by the intermediate yoke 50, the magnetic sensor 60 and the back yoke 70 are prepared and arranged so as to satisfy the positional relation capable of suppressing the amplitude of the waveform of the combined output of the magnetic sensors 60.

Concretely, in the some exemplary embodiments, as shown in FIG. 4A, two magnetic sensing devices Xa and Xb are arranged so that the output of one of the magnetic sensing devices Xa and Xb and the output of the other of the magnetic sensing devices Xa and Xb are opposite in phase. More specifically, two magnetic sensing devices Xa and Xb are arranged at positions different in phase by 140 degrees of electric angle. The electric angle may mean the number of degrees along the circumferential direction that corresponds to an entire width of a pair of poles (i.e., a pair of the north and south poles) as seen in the axial direction of the axis of rotation. In the illustrated embodiment, the electric angle is 40 degrees. Accordingly, two magnetic sensing devices Xa and Xb are arranged at positions where the relation of [electric angle of 40 degrees×3+electric angle of 20 degrees] is satisfied. In other words, two magnetic sensing devices Xa and Xb are arranged at positions where the relation of [electric angle×N+electric angle/2, wherein N is a positive integer>.

In the embodiment in which two magnetic sensing devices Xa and Xb are arranged at the positions shown in FIG. 4A, it is understood from FIG. 4B that the waveform of the combined output obtained by combining the outputs of two magnetic sensors is suppressed in amplitude approximately in halves as compared with the waveform of the output of each magnetic sensing device.

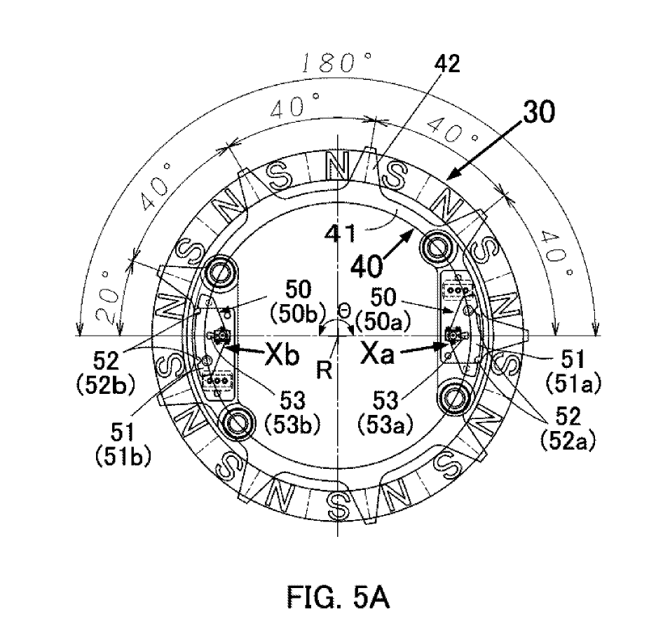

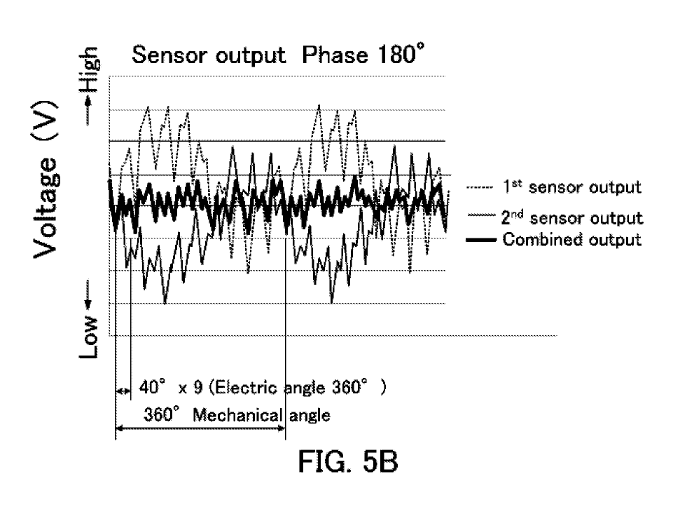

FIG. 5A shows some exemplary embodiments according to the present invention. In this embodiment, two magnetic sensing devices Xa and Xb are arranged at a phase difference of 180 degrees. This embodiment also satisfies the relation of [Electric angle×N+Electric angle/2, where N is a positive integer], and it is understood from FIG. 5B that the waveform of the combined output obtained by combining the outputs of two magnetic sensors is greatly suppressed in amplitude as compared with the waveform of the output of each magnetic sensing device. Since the other structure is the same as that of the embodiment described in FIG. 4A, the detail explanation will be omitted.

It can be configured such that the magnetic detection portion X includes M pieces of facing portions including the first facing portion 51a and the second facing portion 51b. In this case, these facing portions are formed at positions where the circumferential angle thereof satisfies the relational expression of [Electric angle of the permanent magnet×N+Electric angle/(2+M), where N and M are positive integers]. With this, the same effects as mentioned above can be exerted.

In the above exemplary embodiments, two magnetic sensing members Xa and Xb are arranged. However, the present invention is not limited to these embodiments. For example, the number of magnetic sensing members and the positions thereof are not limited as long as a plurality of magnetic sensing members are arranged so as to satisfy the positional relation capable of suppressing the amplitude of the waveform of the combined output of the plurality of magnetic sensors as compared to the amplitude of the waveform of the output of each magnetic sensor, when a plurality of magnetic sensing members are moved in the circumferential direction with respect to the ring body of the magnetic flux inducing ring in a state in which each protrusion of the magnetic flux inducing ring is arranged at an intermediate position of the S-pole and the N-pole of the permanent magnet.

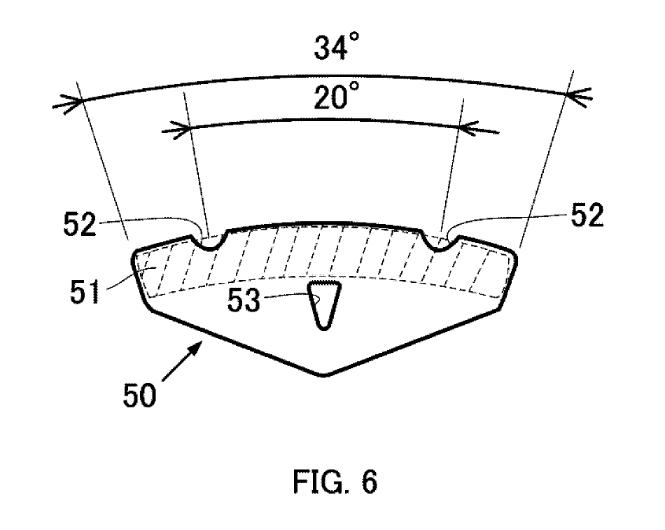

FIG. 6 is a plan view showing an intermediate yoke 50 used in each embodiment. This intermediate yoke 50 is formed into a generally fan-shape including a facing portion 51 which overlaps the ring body 41 of the magnetic flux inducing ring 40 when seen in the axial direction of the shaft 1. The intermediate yoke 50 further includes a pair of cutout portions 52 and 52 formed in the outer peripheral edge of the outer peripheral edge portion so as to separate in the circumferential direction. The pair of cutout portions 52 and 52 are formed at positions corresponding to an electric angle) (20° which is half of the electric angle (40° in the embodiment) of the permanent magnet 30. In some embodiments, the facing portion 51a, 51b each include a protruded portion that protrudes in a radially outward direction of the axis of rotation or shaft 1. In some embodiments, the facing portions 51a, 51b may be dented portions that are dented in a radially inward direction of the axis of rotation or shaft 1. This intermediate yoke 50 further includes a cutout portion 53 of a generally inverted triangular shape formed at a circumferential intermediate position where the cutout portion 53 does not overlap the ring body 41 of the magnetic flux inducing ring 40 when seen in the axial direction of the shaft 1.

Examples of concrete dimensions of each portion of the intermediate yoke 50 are shown in FIG. 6. The reasons for employing the illustrated shape are to reduce the influence of the ring body 41 of the magnetic flux inducing ring 40 magnetized alternately so as to change in polarity in the circumferential direction, i.e., to reduce the minor fluctuations of the output waveform of each magnetic sensor 60 shown in FIGS. 4B and 5B. Accordingly, as mentioned above, by using two or more magnetic sensing members and the intermediate yoke 50 having the shape shown in FIG. 6, the fluctuations of the output waveform of the magnetic sensor which do not contribute to the rotational angular displacement detection can be reduced, which in turn can improve the detection accuracy.

As explained above, in some embodiments, it is configured such that the lever member 10 as a first rotatable member is rotationally displaced in both directions, i.e., the counterclockwise direction and the clockwise direction, with respect to the sprocket 20 as a second rotatable member. Therefore, the direction of the magnetic flux passing through the magnetic sensor 60 changes depending on the relative rotational angular displacement direction of both the rotatable members. Therefore, when an electric motor (not illustrated) as an auxiliary power source is controlled using the output of the magnetic sensor 60 via a control circuit (not illustrated), in a power assist wheelchair for example, not only the forward driving but also the reverse driving can be assisted.

Further, in the aforementioned embodiments, the case in which a coil spring S is used as an elastic member is exemplified. It should be noted, however, that various springs can be utilized and it can be configured to detect the relative rotational angular displacement or the rotational torque of the first and second rotatable members using other elastic member of various resin or metal, e.g., a torsional dumper, etc. Further, as a permanent magnet, the present invention may use cylindrical permanent magnet.

According to some embodiments of the present invention, the relative rotational angular displacement detection device includes the permanent magnet 30, the magnetic flux inducing ring 40, the intermediate yoke 50, the magnetic sensor 60, and the back yoke 70. The permanent magnet 30 is fixed to one of the pair of rotatable members 10 and 20 and includes S-poles and N-poles magnetized in the axial direction of the shaft 1 and arranged alternately in the circumferential direction of the shaft 1.

The magnetic flux inducing ring 40 includes an annular ring body 41 fixed to the other of the pair of rotatable members 10 and 20 and arranged so as not to overlap the permanent magnet 30 when seen in the axial direction of the shaft 1, and a plurality of protrusions 42 protruded from the ring body 41 in a radially outward direction of the shaft 1 and arranged so as to overlap the permanent magnet 30 when seen in the axial direction of the shaft 1.

The intermediate yoke 50 is arranged adjacent to the ring body 41 of the magnetic flux inducing ring 40, and the back yoke 70 constitutes a magnetic flux inducing circuit together with the intermediate yoke 50. The magnetic sensor 60 is arranged between the intermediate yoke 50 and the back yoke 70.

Therefore, the relative rotational angular displacement detection device can assuredly detect the relative rotational angular displacement of the first rotatable member 10 and the second rotatable member 20 with a simple structure. Further, the relative rotational angular displacement detection device is configured to detect the magnetic flux passing through the magnetic flux inducing path constituted by the intermediate yoke 50 and the back yoke 70 with the magnetic sensor 60 without positively form a magnetic closed loop of the permanent magnet 30. This further simplifies the structure, the production and the assembly of the device, which in turn can reduce the cost.

Furthermore, when the magnetic sensing members are rotationally moved in the circumference direction with respect to the ring body of the magnetic flux inducing ring in a state in which the relative position of the permanent magnet and the magnetic flux inducing ring is maintained, both the magnetic sensors are arranged so as to satisfy the positional relation that the amplitude of the output waveform obtained by combining the output of the magnetic sensors is reduced as compared with the amplitude of the output waveform of each magnetic sensor. Therefore, the output waveform obtained by combining the outputs of both the magnetic sensors becomes flat, which can reduce the possible erroneous detections. Thus, the detection accuracy can be improved.

It should be understood that the terms and expressions used herein are used for explanation and have no intention to be used to construe in a limited manner, do not eliminate any equivalents of features shown and mentioned herein, and allow various modifications falling within the claimed scope of the present invention.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.”

The present invention can be preferably applied to a relative rotational angular displacement detection device for use in a power assist system for, e.g., a power assist wheelchair, a power assist bicycle, a power steering wheel, etc., to detect a relative rotational angular displacement of a pair of rotatable members relatively rotatable in the circumferential direction of a rotation shaft. The present invention can also be preferably applied to a torque detection device or a torque control device using the detection device.

1. A relative rotational angular displacement detection device, comprising:
a pair of rotatable members rotatable by 360 degrees around an axis of rotation, the rotatable members being rotatable relative to each other around the axis of rotation in a circumferential direction;
a permanent magnet attached to a first of the pair of rotatable members so as to rotate with the first rotatable member, the permanent magnet including magnetic poles arranged so as to alternate in polarity along the circumferential direction;
a magnetic flux inducing ring including
an annular ring body attached to a second of the pair of rotatable members so that the magnetic flux inducing ring rotates with the second rotatable member, the annular ring body arranged coaxially with the axis of rotation, and
a plurality of protrusions protruding from the ring body and arranged so as to face the magnetic poles in a magnetization direction of the permanent magnet,
the ring body being magnetized and having a strength of magnetization that changes depending on positions of the protrusions relative to positions of the magnetic poles; and
a magnetic detection portion configured to detect a magnetic flux of the ring body, the magnetic detection portion including
a first facing portion arranged to face a first part of the ring body to form a first magnetic flux path with the first part of the ring body,
a second facing portion facing a second part of the ring body and arranged at a position apart from the first facing portion in the circumferential direction to form a second magnetic flux path with the second part of the ring body,
a first magnetic sensor configured to detect magnetic flux of the first magnetic flux path, and
a second magnetic sensor configured to detect magnetic flux of the second magnetic flux path, and
both the first facing portion and the second facing portion are fixed in the circumferential direction so as to not rotate about the axis of rotation with each of the permanent magnet and the magnetic flux inducing ring.

2. The relative rotational angular displacement detection device as recited in claim 1,
wherein as seen in an axial direction of the axis of rotation,
an electric angle is a number of degrees along the circumferential direction that corresponds to an entire width of a pair of the magnetic poles, the pair of magnetic poles including an n-pole and an s-pole adjacent to the n-pole,
the first facing portion and the second facing portion are arranged at positions where a central angle formed between the first facing portion and the second facing portion satisfies a relational expression of:
the electric angle×N+the electric angle/2, where N is a positive integer.

3. The relative rotational angular displacement detection device as recited in claim 2,
wherein the magnetic detection portion includes
a first intermediate yoke arranged between the first magnetic sensor and the ring body so as to face the ring body, and
a second intermediate yoke arranged between the second magnetic sensor and the ring body so as to face the ring body, further wherein the first facing portion is provided at the first intermediate yoke, and
further wherein the second facing portion is provided at the second intermediate yoke.

4. The relative rotational angular displacement detection device as recited in claim 3, wherein the first magnetic sensor is configured to receive the magnetic flux of the first magnetic flux path, and the second magnetic sensor is configured to receive the magnetic flux of the second magnetic flux path.

5. The relative rotational angular displacement detection device as recited in claim 2,
wherein the magnetic detection portion includes a
first intermediate yoke arranged between the first magnetic sensor and the ring body so as to face the ring body, and
a second intermediate yoke arranged between the second magnetic sensor and the ring body so as to face the ring body,
wherein the first facing portion is provided at the first intermediate yoke, and the second facing portion is provided at the second intermediate yoke,
wherein the first intermediate yoke forms a part of the first magnetic flux path, and the first magnetic sensor is configured to detect the magnet flux of the first magnetic flux path by detecting a magnetic flux of the first intermediate yoke, and
further wherein the second intermediate yoke forms a part of the second magnetic flux path, and the second magnetic sensor is configured to detect the magnetic flux of the second magnetic flux path by detecting a magnetic flux of the second intermediate yoke.

6. The relative rotational angular displacement detection device as recited in claim 1, wherein as seen in an axial direction of the axis of rotation,
an electric angle is a number of degrees along the circumferential direction that corresponds to an entire width of a pair of the magnetic poles, the pair of magnetic poles including an n-pole and an s-pole adjacent to the n-pole,
the magnetic detection portion includes M pieces of facing portions including the first facing portion and the second facing portion, and
the facing portions are arranged at positions where each facing portion forms a central angle with an adjacent one of the facing portions that satisfies a relational expression of:
the electric angle×N+the electric angle/(2+M), where N and M are positive integers.

7. The relative rotational angular displacement detection device as recited in claim 6,
wherein the magnetic detection portion includes
a first intermediate yoke arranged between the first magnetic sensor and the ring body so as to face the ring body, and
a second intermediate yoke arranged between the second magnetic sensor and the ring body so as to face the ring body,
wherein the first facing portion is provided at the first intermediate yoke, and
wherein the second facing portion is provided at the second intermediate yoke.

8. The relative rotational angular displacement detection device as recited in claim 7,
wherein the first intermediate yoke forms a part of the first magnetic flux path,
further wherein the second intermediate yoke forms a part of the second magnetic flux path,
further wherein the first magnetic sensor is configured to receive the magnetic flux of the first magnetic flux path via the first intermediate yoke, and the second magnetic sensor is configured to receive the magnetic flux of the second magnetic flux path via the second intermediate yoke.

9. The relative rotational angular displacement detection device as recited in claim 1,
wherein the magnetic detection portion includes
a first intermediate yoke arranged between the first magnetic sensor and the ring body so as to face the ring body, and
a second intermediate yoke arranged between the second magnetic sensor and the ring body so as to face the ring body,
wherein the first facing portion is provided at the first intermediate yoke, and the second facing portion is provided at the second intermediate yoke,
wherein the first intermediate yoke forms a part of the first magnetic flux path, and the first magnetic sensor is configured to detect the magnet flux of the first magnetic flux path by detecting a magnetic flux of the first intermediate yoke, and
further wherein the second intermediate yoke forms a part of the second magnetic flux path, and the second magnetic sensor is configured to detect the magnetic flux of the second magnetic flux path by detecting a magnetic flux of the second intermediate yoke.

10. The relative rotational angular displacement detection device as recited in claim 9, wherein the first facing portion includes a first magnetic flux inducing portion, and the second facing portion includes a second magnetic flux inducing portion.

11. The relative rotational angular displacement detection device as recited in claim 10, wherein the first magnetic flux inducing portion is a protruded portion protruded in a radially outward direction or a dented portion dented in a radially inward direction, and the second magnetic flux inducing portion is a protruded portion protruded in a radially outward direction or a dented portion dented in a radially inward direction.

12. The relative rotational angular displacement detection device as recited in claim 1,
wherein as seen in an axial direction of the axis of rotation,
an electric angle is a number of degrees along the circumferential direction that corresponds to an entire width of a pair of the magnetic poles, the pair of magnetic poles including an n-pole and an s-pole adjacent to the n-pole,
the first facing portion and the second facing portion are arranged so that a center angle formed between the first facing portion and the second facing portion is ¼ or more of the electric angle and ¾ or less of the electric angle.

13. A torque detection device equipped with the relative rotational angular displacement detection device as recited in claim 1, comprising:
an elastic member arranged between the pair of rotatable members,
wherein an urging force is always given to the pair of rotatable members by the elastic member in a relative rotational direction, and
wherein the pair of rotatable members is provided with a relative rotation restricting portion, the relative rotation restriction portion is configured to prevent a rotation of the pair of rotatable members relative to each other after one of the pair of rotatable members is relatively rotated, against the urging force of the elastic member, by a certain angle with respect to the other of the pair of rotatable members.

14. A torque control device equipped with the relative rotational angular displacement detection device as recited in claim 1, comprising:
a rotary driving member connected to the one rotatable member, wherein a rotational force is given to the rotary driving member by a user,
a power source configured to give a rotational force to the other of the pair of rotatable members, and
a control portion configured to control the rotational force given to the other of the pair of rotatable members by the power source depending on an output of the magnetic detection portion when the one of the pair of rotatable members is relatively rotated by a certain rotational angle with respect to the other of the pair of rotatable members.

15. A power assist wheelchair equipped with the torque control device as recited in claim 14.

16. A power assist straddle-type vehicle equipped with the torque control device as recited in claim 14.

17. A power steering device equipped with the torque control device as recited in claim 14.

18. The relative rotational angular displacement detection device as recited in claim 1, wherein the magnetic detection portion detects the magnetic flux of the ring body based upon both of the detected magnetic flux of the first magnetic flux path and the detected magnetic flux of the second magnetic flux path.
